(19) United States
(12) Patent Application Publication
(10) Pub. No.: US 2021/0142357 A1
(43) Pub. Date: May 13, 2021

(54) SYSTEMS AND METHODS FOR TARGETED EMAIL MARKETING

(71) Applicant: Capital One Services, LLC, McLean, VA (US)

(72) Inventors: Edmond TRUONG, McLean, VA (US); Jie SHEN, McLean, VA (US); Phanindra Venkatesh RAO, McLean, VA (US); Sunil Subrahmanyam VASISHT, McLean, VA (US); Patrick James MANION, McLean, VA (US); Meng SUN, McLean, VA (US)

(73) Assignee: Capital One Services, LLC, McLean, VA (US)

(21) Appl. No.: 17/123,024

(22) Filed: Dec. 15, 2020

Related U.S. Application Data
(62) Division of application No. 16/381,380, filed on Apr. 11, 2019.

(51) Int. Cl. G06Q 30/02; H04L 12/58; G06K 9/62

(52) U.S. Cl. CPC G06Q 30/0244; G06Q 30/0246; G06K 9/6257; H04L 51/22

(57) ABSTRACT

A system for targeted email marketing includes one or more processors, and a memory storing instructions. When executed by the one or more processors, the instructions cause the system to perform operations including: generating email templates respectively corresponding to different customer marketing communications; sending first emails to first customers, in which each of the first emails includes one of the email templates in accordance with an initial allocation; compiling response information from the first customers and updating a bandit model in accordance with the response information, the bandit model for determining an allocation of the email templates to customers; determining, by the bandit model, a revised allocation of the email templates to second emails; and sending the second emails to second customers in accordance with the revised allocation.

### CROSS-REFERENCE TO RELATED APPLICATION

This application is a divisional application of U.S. patent application Ser. No. 16/381,380, filed Apr. 11, 2019, the content of which is incorporated herein in its entirety by reference.

### TECHNICAL FIELD

The disclosed embodiments generally relate to systems and methods for targeted email marketing.

### BACKGROUND

A/B testing is widely applied in email marketing campaigns, as well as other advertising activities, to compare performances between two different email advertising variants. By randomly sending two versions of an email advertisement that differ in email advertisement design and/or content, A/B testing can determine the relative efficacy of the two versions. A strategy for conducting the email marketing campaign can thereby be determined.

However, this approach can be a time-consuming process that limits the speed of adjusting an email advertising strategy, especially when there are multiple candidate versions of email advertisements to be tested. In addition, A/B testing may require significant manual effort for evaluation and adjustment of candidate email advertisements, which may not only result in high labor cost, but may also cause bias and low accuracy in determining efficacy. Further, A/B test only provides a one-size-fits-all strategy, which may not be the best solution for a diverse customer base.

Thus, there is a need for systems and methods capable of developing an effective email marketing campaign with greater efficiency and flexibility.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The disclosed embodiments include a system for targeted email marketing. In some embodiments, the system includes one or more processors, and a memory storing instructions. When executed by the one or more processors, the instructions cause the system to perform operations including: generating email templates respectively corresponding to different customer marketing communications; sending first emails to first customers, in which each of the plurality of first emails includes one of the plurality of email templates in accordance with an initial allocation; compiling response information from the first customers and updating a bandit model in accordance with the response information, the bandit model for determining an allocation of the email templates to customers; determining, by the bandit model, a revised allocation of the email templates to second emails; and sending the second emails to second customers in accordance with the revised allocation.

The disclosed embodiments also include a method for targeted email marketing. The method includes: generating a plurality of email templates respectively corresponding to different customer marketing communications; determining a number of customers for receiving each email template in accordance with an initial allocation, and sending a plurality of first emails to a plurality of first customers, each of the first emails including one of the email templates in accordance with the initial allocation; compiling information about responses of the first customers to the first emails; determining a revised allocation of the email templates by a bandit model in accordance with the response information from the plurality of first customers to the first emails; and determining a number of customers for receiving each of the email templates in accordance with the revised allocation of the email templates, and sending a plurality of second emails to a plurality of second customers.

The disclosed embodiments further include a non-transitory computer-readable medium, storing instructions that are executable by one or more processors to perform a method for targeted email marketing. The method includes: generating a plurality of email templates respectively corresponding to different customer marketing communications; determining a number of customers to receive each of the plurality of email templates in accordance with an allocation, and sending a plurality of emails to a plurality of customers, in accordance with the allocation, intermittently in a plurality of cycles; and in each of the plurality of cycles, updating the allocation of the plurality of email templates to the numbers of customers for a next cycle, by a bandit model, in accordance with responses of the plurality of customers receiving the plurality of emails in a previous cycle.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a schematic diagram of an exemplary system for conducting targeted email marketing, consistent with disclosed embodiments;

FIG. 2 is a schematic diagram illustrating further aspects of the exemplary system for conducting targeted email marketing, consistent with disclosed embodiments;

FIG. 3 is a flowchart of an exemplary method for conducting targeted email marketing, consistent with disclosed embodiments;

FIG. 4 is a flowchart illustrating in greater detail an operation of the exemplary method in FIG. 3 for conducting targeted email marketing, consistent with disclosed embodiments;

FIG. 5 is a flowchart illustrating in greater detail another operation of the exemplary method in FIG. 3 for targeted email marketing, consistent with disclosed embodiments;

FIG. 6 is a schematic diagram which illustrates an example of reallocating email templates in successive email cycles of sending candidate email advertisements, consistent with disclosed embodiments;

FIG. 7 is a schematic diagram which illustrates an automated pipeline for identifying segments of customers for receiving email advertisements, consistent with disclosed embodiments; and

FIG. 8 is a bar chart illustrating an example of customer response estimation values, consistent with disclosed embodiments.

### DETAILED DESCRIPTION

Traditionally, A/B testing can be applied to provide a comparison between two different “creatives” (A and B) sent in an email marketing campaign to determine which creative has a better performance in the campaign. In addition to the A/B testing, design of experiments (DOE) may also be applied to determine what combination of imagery, wording, and/or positioning works better with customers. For example, by implementing DOE, two or more variants can be provided in the campaign at the same time during a test. Contribution of each part (e.g., the imagery, wording, and/or positioning) to customer responses can be analyzed and estimated after the test. Thus, an optimal design with the combination that is predicted to deliver a high response can only be rolled out in a following stage of the campaign. As used herein, a “creative” refers to content for representing an advertisement, for example, images, characters, videos, and/or sounds for inclusion in an email advertisement.

As used herein, the terms “users” and “customers” are used interchangeably to refer to prospective recipients of email advertisements. Further, “customers” may refer to either of existing or potential customers.

Performance of a creative during testing may be assessed in accordance with performance criteria such as a number of clicks on, responses to, or sales resulting from an email advertisement containing a particular creative. Other criteria may also be used to determine which version, or variant, of a creative achieves a better performance. For example, the performance of the creative may be measured by a responding rate or a click through rate, e.g., the ratio of users who click on a link to the number of total users who view an email, to determine which creative is more effective and/or more profitable.

Typically, A/B testing includes randomly distributing different creatives via email in an initial phase to customers on a mailing list, waiting for feedback results of the testing to be collected from customers, manually evaluating the testing results to determine which creative provides a successful customer experience or set of experiences, based on performance criteria such as described above, and then adjusting the creatives to be sent in a next round of the campaign, in order to send a “winning” creative, i.e., the creative that resulted in the most successful customer experience, to recipients in the mailing list in a next phase.

However, in a manual evaluation of A/B testing, it is difficult for an evaluator to precisely evaluate how the content of the creative, and/or design of a particular segment in the creative, affect the creative performance. That is, actual factors in the winning creative that resulted in the successful customer experience cannot be identified. In addition, a lengthy wait for results in A/B testing may cause a significant delay in making adjustments. Email marketing, by nature, relies on sending content and receiving feedback, and, as a result, is time consuming because of the need to wait until a sample size is large enough to determine the winning creative. In some cases, the process of waiting for feedback from customers may even take several months, which causes high opportunity costs, since many creatives with lower performance and the single winning creative may be randomly distributed among email advertisements sent to customers in this lengthy process.

Moreover, existing processes for adjusting creatives are manual in scope, which means an administrator is involved in the processes of designing creatives, analyzing feedback results, and making judgments to determine the winning creative. The manual process leads to inefficiencies and inaccurate variants being sent to customers. Furthermore, since only one global winning creative is ultimately identified based on an entire population of customers, different needs of different customers are not taken into consideration. That is, the emails sent to customers are not personalized based on characteristics of the receptive customers, which may hinder improvement in advertising performance, since many potential target customers receive email advertisements based on suboptimal creatives.

In some embodiments of the present disclosure, improved methods for targeted email marketing are provided that include a contextual multi-armed bandit engine to identify user segments and strategically find relationships between creatives and different customer segments. Thus, when creatives are added to, or removed from, a marketing campaign conducted using systems and methods consistent with the present disclosure, a determination is made as to which customers are most responsive to which creatives and, based on the determination, personalized marketing emails are sent to customers in an automated process. Furthermore, the contextual multi-armed bandit engine is self-updated in each marketing campaign cycle, and learns from historical data collected from customers in previous cycles, which brings dynamic and real-time response adjustments to the campaign.

Thus, the disclosed systems and methods overcome problems of traditional A/B testing in email marketing practice, such as time consuming, costly manual processing and lack of customer personalization. Accordingly, a marketing campaign utilizing the improved systems and methods disclosed herein can be more successful, with quick adaptability, automated processing, and personalization of marketing content. The following disclosure provides exemplary systems and methods for targeted email marketing for realizing at least some of the above advantages and benefits over conventional systems.

Reference will now be made in detail to exemplary embodiments, examples of which are illustrated in the accompanying drawings and disclosed herein. Wherever convenient, the same reference numbers will be used throughout the drawings to refer to the same or like parts.

FIG. 1 is a schematic diagram of an exemplary system 100 for conducting targeted email marketing in accordance with some embodiments of the present disclosure. System 100 for conducting targeted email marketing is configured to distribute email advertisements to existing or potential customers. For example, in some embodiments, system 100 is configured to perform an email marketing campaign by sending emails including information related to an advertisement to customers in a mailing list. The email marketing campaign can be conducted periodically, for example, on a daily, a weekly, a monthly, or an annual basis, but the present disclosure is not limited thereto. As used herein, the term “email” may be used to broadly apply to PC-based email, non-PC-based email, other text-based messaging such as IM, SMS, etc., voice messaging, a push notification, or other communication media/platforms.

Any one of the emails sent by system 100 may include one corresponding “creative,” but the present disclosure is not limited thereto. In some embodiments, an email sent by system 100 may include multiple corresponding creatives associated with advertisements in different categories. For example, an email can include a corresponding creative associated with credit cards, a creative associated with car loans, and a creative associated with saving accounts. Different creatives have creative IDs for identification in system 100. As shown in FIG. 1, creatives C1, C2, C3, and C4 are four different creatives to be sent in the email marketing campaign. It is noted that the number of creatives shown in FIG. 1 is merely an example for further understanding of the present disclosure, and is not meant to limit the present disclosure. In various embodiments, the number of creatives may be any number and determined based on practical needs of the marketing campaign.

The lower portion of FIG. 1 illustrates a population of customers that are differentiated according to shading of the illustrated customer symbols. The different shadings indicate different customer segments, which may have different needs and thus different reactions to the same creative. That is, for the same email content, i.e., same creative or creatives, one segment of customers may be more likely to favorably respond to the email solicitations, compared to another segment of customers. Similarly, different customer segments may have different preferences for the creatives. Alternatively stated, while a creative (e.g., creative C1) is attractive to some customers (e.g., users U1, U2), another creative (e.g., creative C2) is attractive to other customers (e.g., users U3), and yet another creative (e.g., creative C4) is attractive to yet other customers (e.g., users U4).

In various embodiments of the present disclosure, system 100 applies an approach driven by a machine learning algorithm to automate the email marketing process and provide personalized creatives and/or email content by building a self-updated model which learns from customer feedback. More particularly, system 100 applies a bandit algorithm, such as a contextual bandit algorithm. The contextual bandit algorithm is an algorithm for solving a contextual multi-armed bandit problem. Information about the customers and the creatives is referred to herein as the “context” for the contextual bandit algorithm.

A multi-armed bandit problem, sometimes also called an N-armed bandit problem, is a problem in which a fixed limited set of resources are allocated between competing or alternative choices, i.e., multiple “arms” of bandits, in a way that maximizes long term expected gain for the resources. Properties of the choices are partially known at the time of allocation of the resource, and may become further understood by allocating resources to the choice. The multi-armed bandit problem models an agent, i.e., a bandit model, that simultaneously attempts to acquire new knowledge, which is also called “exploration”, and to optimize decisions based on existing knowledge, which is called “exploitation.” The agent attempts to balance the exploration and the exploitation in order to maximize a total value over a period of time considered.

A contextual multi-armed bandit problem is a multi-armed bandit problem in which an agent analyzes a multi-dimensional feature vector, i.e., a context vector, associated with a current iteration before choosing between arms in each iteration. A contextual multi-armed bandit model uses these context vectors along with rewards of the arms played in the past to make the choice of the arm to play in the current iteration. Over time, the contextual multi-armed bandit model's aim is to collect enough information about how context vectors and rewards relate to each other, so that choices can be made by analyzing the context vectors.

The following publications include information concerning the bandit model, the bandit algorithm, the multi-armed bandit and the contextual multi-armed bandit, and are incorporated by reference herein as if fully described herein: Russo, D. J., Van Roy, B., Kazerouni, A., Osband, I., & Wen, Z, 2018, “A tutorial on Thompson sampling,” Foundations and Trends in Machine Learning, Vol. 11: No. 1, pp 1-96; Agarwal, A., Hsu, D., Kale, S., Langford, J., Li, L., & Schapire, R, 2014, “Taming the monster: A fast and simple algorithm for contextual bandits,” International Conference on Machine Learning (pp. 1638-1646); and Chapelle, O., Manavoglu, E., & Rosales, R., 2015, “Simple and scalable response prediction for display advertising,” ACM Transactions on Intelligent Systems and Technology (TIST), 5(4), 61.

In some embodiments, system 100 builds the bandit model by using the contextual bandit algorithm, an extreme gradient boosting algorithm, a regression algorithm, or a combination thereof, but the present disclosure is not limited thereto. For example, system 100 may operate a contextual bandit API that offers an accessible optimization tool based on the contextual bandit algorithm to build the bandit model, which is configured to determine the allocation of creatives to be included in emails sent to customers. Operations regarding the contextual bandit API will be discussed in detail below with an accompanying figure. Those skilled in the art can understand how to build various bandit models using an appropriate algorithm, and further explanation is omitted herein for the sake of brevity.

In applying the contextual bandit algorithm to email marketing herein, the performance of competing creatives is unclear before testing. By sending creatives and recording responses from customers, the contextual bandit algorithm can update the bandit model built by the contextual multi-armed algorithm to optimize the allocation of the creatives per email drop, i.e., each cycle of sending emails in the marketing campaign. Thus, system 100 may determine what creative and/or email content to be distributed to which segment of customers based on the updated model in a next email drop.

Accordingly, system 100 can effect a prompt adjustment to automatically re-allocate the distribution of creatives and reduce time and cost. For example, in a marketing campaign that sends emails on a daily basis, the bandit model may be updated in each email cycle, and the distribution of creatives may be re-allocated day-to-day. Thus, the bandit model may be trained and refined within a relatively short period, such as one week (e.g., 7 email cycle). Thus, comparing to AB testing, system 100 provides a quick response and flexibility. In addition, system 100 also optimizes use of creatives by leveraging available customer data to match the email recipient with the creative likely to garner a favorable response, in order to maximize the advertising efficiency in the marketing campaign.

FIG. 2 is a schematic diagram illustrating further aspects of exemplary system 100 in accordance with some embodiments of the present disclosure. In some embodiments, system 100 may be a server to implement system 100 for conducting targeted email marketing shown in FIG. 1, but is not limited thereto. In some embodiments, system 100 may be associated with a financial service provider (not shown), such as a bank, a credit card company, a lender, brokerage firm, or any other type of financial service entity that generates, provides, manages, and maintains financial service accounts for one or more of customers. In some embodiments, system 100 may be configured as a particular apparatus, system, and the like, based on the storage, execution, and/or implementation of software instructions that perform one or more operations consistent with the disclosed embodiments. System 100 may be standalone, or it may be part of a subsystem, which may be part of a larger system. For example, system 100 may represent distributed servers that are remotely located and communicate over a public network (e.g., network 150) or a dedicated network, such as a LAN, for a financial service provider.

As shown in FIG. 2, system 100 includes a bus 110 or other communication mechanism for communicating information, and one or more hardware processor(s) 120 communicatively coupled with bus 110 for processing information. Hardware processor(s) 120 can be, for example, one or more central processors or microprocessors. Bus 110 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

System 100 further includes one or more storage device(s) 130. Storage device(s) 130 can be various computer-readable media implemented in any method or technology for storage of information such as computer-readable instructions, data structures, program modules or other data. Storage device(s) 130 can be communicatively coupled with processor(s) 120 via bus 110. In some embodiments, storage device(s) 130 may include a main memory, which can be used for storing temporary variables or other intermediate information during execution of instructions by processor(s) 120. Such instructions, after being stored in non-transitory storage media accessible to processor(s) 120, render system 100 into a special-purpose machine that is customized to perform operations specified in the instructions. The term “non-transitory media” as used herein refers to any non-transitory media storing data or instructions that cause a machine to operate in a specific fashion. Such non-transitory media can include non-volatile media and/or volatile media. Non-transitory media include, for example, optical or magnetic disks, dynamic memory, a floppy disk, a flexible disk, hard disk, solid state drive, magnetic cassettes, magnetic tape, or any other magnetic data storage medium, a CD-ROM, digital versatile disks (DVD) or any other optical data storage medium, any physical medium with patterns of holes, a Random Access Memory (RAM), a read-only memory (ROM), a Programmable Read-Only Memory (PROM), a EPROM, a FLASH-EPROM, NVRAM, flash memory, or other memory technology and/or any other storage medium with the same functionality that can be contemplated by persons of ordinary skill in the art to which this disclosure pertains.

In the embodiments consistent with system 100 shown in FIG. 2, storage device(s) 130 may include a memory, which includes computer-readable media in the form of volatile and/or nonvolatile memory such as read only memory (ROM) 132 and random access memory (RAM) 134. A basic input/output system (BIOS) containing the basic routines that help to transfer information between elements within system 100 is typically stored in ROM 134. Additionally, RAM 132 may contain operating system (OS), applications, other programmable code, and programs. The RAM 132 typically contains data and/or program modules that are immediately accessible to and/or presently being operated on by the processor(s) 120.

In some embodiments, system 100 may also include other removable/non-removable, volatile/nonvolatile computer media. By way of example, FIG. 2 illustrates a hard disk 140 that reads from or writes to non-removable, nonvolatile magnetic media. In some other embodiments, system 100 may also include a memory device that may be an optical disk drive or a magnetic disk drive that reads from or writes to a removable, a nonvolatile storage medium such as an optical disk or magnetic disk. Other removable/non-removable, volatile/nonvolatile computer storage media that can be used in exemplary system 100 include, but are not limited to, magnetic tape cassettes, flash memory cards, digital versatile disks, digital video tape, solid state RAM, and solid state ROM. Hard disk 140 and storage device(s) 130 may be connected to bus 110 through a storage path.

Hard disk 140 and storage device(s) 130 may further include client data, which may include information about particular customers of the financial service provider, such as client account information, debit or credit card information, history of purchase or payment transactions, financial statements, and one or more transaction rules and location information according to the disclosed embodiments. Client data may include a data record associating a client account with one or more other accounts according to the one or more transaction rules. Client data may further contain one or more user profiles, including information such as a credit score, an income value, an inquiry number, an annual application number corresponding to individual client accounts. In some embodiments, client data may be stored in a database, which may be an external storage device in communication with system 100 via a network 150 or any other suitable network.

System 100 can transmit data to and communicate with other servers, send emails, and receive response from client terminals through network 150. Network 150 may be a local network, an internet service provider, internet, or any combination thereof. A communication interface 160 of system 100 is connected to network 150. In addition, system 100 can be coupled via bus 110 to one or more peripheral devices 170, which includes displays (e.g., cathode ray tube (CRT), liquid crystal display (LCD), touch screen, etc.), input devices (e.g., keyboard, mouse, soft keypad, etc.), or other output devices (e.g., speaker, headphone, etc.).

In some other embodiments, system 100 can also be implemented using customized hard-wired logic, one or more ASICs or FPGAs, firmware, or program logic that in combination with the server causes system 100 to be a special-purpose machine.

System 100 may include or may access one or more storage device(s) 130 configured to store data and/or software instructions used by processor(s) 120 to perform operations consistent with the disclosed embodiments. For example, processor(s) 120 can be configured to execute a set of instructions stored in the storage device(s) 130 to cause system 100 to perform a method for targeted email marketing, in order to send emails including different creatives to different customer segments to achieve the creative optimization mentioned above.

Various forms of media can be involved in storing one or more sequences of one or more instructions for processor(s) 120 to execute. For example, the instructions can initially be stored on a magnetic disk or solid-state drive of a remote computer. The remote computer can load the instructions into its dynamic memory and send the instructions over a telephone line using a modem. A modem local to system 100 can receive the data on the telephone line and use an infrared transmitter to convert the data to an infra-red signal. An infra-red detector can receive the data carried in the infra-red signal and appropriate circuitry can place the data on bus 110. Bus 110 carries the data to the main memory within storage device(s) 130, from which processor(s) 120 retrieves and executes the instructions.

The disclosed embodiments are not limited to separate programs or computers configured to perform dedicated tasks. For example, storage device(s) 130 may store a single program or multiple programs. Additionally, system 100 may execute one or more programs located remotely from system 100. For example, system 100 may access one or more remote programs stored in a remote component (such as a database) that, when executed, perform operations consistent with the disclosed embodiments. In addition, other components known to one of ordinary skill in the art may be included in system 100 to process, transmit, provide, and receive information consistent with the disclosed embodiments.

By executing the instructions and/or programs stated above, system 100 may divide targeted customers in a current cycle into different segments (e.g., segments S1, S2, S3, and S4) to receive emails 210, 220, 230, 240 respectively including creatives C1, C2, C3 and C4. Based on the feedback information from the email recipients in the current cycle, system 100 may accordingly update the allocation of creatives C1, C2, C3 and C4 to be distributed among targeted customers in a next email cycle. In some embodiments, system 100 may only send the email once to a specific customer during the whole email marketing campaign. That is, a customer will not be in recipient lists in two different cycles. In other embodiments, system 100 may target the same customer in different cycles, and send multiple emails to the same customers in respective cycles, and these email may include the same or different creatives. In addition, in some embodiments, when one or more new creatives are designed and added in the marketing campaign, system 100 may perform a similar process and determine a new allocation to distribute the existing creatives and the newly introduced creatives respectively to targeted customers. Moreover, in some embodiments, system 100 may be configured to design or suggest new creatives, or remove existing creatives from the marketing campaign.

FIG. 3 is a flowchart of an exemplary method 300 by which system 100 conducts targeted email marketing, consistent with the disclosed embodiments. In the following description, reference is made to certain components of FIG.1 and FIG. 2 for purposes of illustration. It should be appreciated, however, that other implementations are possible, including components other than those illustrated in FIG.1 and FIG. 2.

At step 310, system 100 generates a plurality of email templates (e.g., including creatives C1, C2, C3 and C4 in FIGS. 1 and 2) respectively corresponding to different customer marketing communications. Different templates or creatives are generated in association with different customer needs that have been identified and prioritized. For example, creatives C1, C2, C3 and C4 may respectively correspond to needs for securing long-term financial stability, finding a suitable automotive vehicle, credit consciousness, and getting ready for visiting a new or used car dealer. Based on these need states, creatives C1, C2, C3 and C4 and corresponding layouts and/or areas in the email to display the creatives C1, C2, C3 and C4 are generated. Alternatively stated, different slogans, images, videos, etc., may be included in the email templates to emphasize the corresponding customer needs. For example, a slogan message included in a creative in association with the need for finding a suitable automotive vehicle may be “Find a Car You Love,” while a slogan message included in a creative associated with the need for credit consciousness may be “Credit-conscious Car Shopping.”

At step 320, in a first email cycle, system 100 sends first emails (e.g., emails 210, 220, 230, and 240 in FIG. 2) to first customers (e.g., customers in segments 51, S2, S3, and S4 in FIG. 2). In some embodiments, each of the first emails includes one of the email templates in accordance with an initial allocation. For example, in some embodiments, the initial allocation is initialized as a uniform allocation of the email templates. That is, in the first email cycle, system 100 may send emails containing the four exemplary creatives C1, C2, C3, and C4 randomly in first emails to the selected customers.

At step 330, system 100 determines a number of customers for receiving each corresponding email template in accordance with the allocation. For example, system 100 may determine to send 300,000 emails in total in the first email cycle. If the initial allocation is initialized as a uniform allocation, for each of the four creatives, the system 100 may select 75,000 customers in the mailing list as the recipients to receive corresponding advertising emails. In various embodiments, system 100 may determine the recipients in different ways. In some examples, system 100 may simply select recipients randomly. In some other examples, system 100 may select recipients based on customer characteristics (e.g., initial or preliminary segments), in order to ensure the diversity of recipients receiving the same creative.

After determining the number of customers, at step 340, system 100 sends emails to corresponding customers, also referred to herein as first customers based on receiving emails in the first email cycle. Thus, the first customers targeted in the first email cycle each receives an email which includes one of the four creatives. It is also noted that in some other embodiments, one email template may include two or more creatives, and the embodiments discussed here are merely examples and not meant to limit the disclosure.

At step 350, after the emails are sent out, system 100 compiles response information from the first customers who receives the emails and updates a bandit model in accordance with the response information. In some embodiments, the response information includes customer characteristics, content characteristics corresponding to the email templates, and performance criteria, which are discussed in detail below.

For further understanding of the operation of step 350, reference is made to FIG. 4. FIG. 4 is a flowchart illustrating in greater detail operations of step 350 in method 300, consistent with disclosed embodiments. As shown in FIG. 4, in some embodiments, step 350 further includes steps 351, 352, and 353.

At step 351, system 100 obtains one or more customer characteristics corresponding to respective ones of the customers, and one or more content characteristics corresponding to the email templates of the emails received by the respective ones of the customers. More particularly, processor(s) 120 may retrieve customer characteristic(s) and/or content characteristic(s) from storage device(s) 130 or an external database containing such information via wired or wireless network, e.g., network 150. For example, the customer characteristics may include customer information related to financial activities such as a credit score (e.g., a FICO score), an income amount, a number of credit inquiries, an annual number of credit applications, or a combination thereof. In some embodiments, the customer characteristics may also include personal information such as gender, age, occupation, but the present disclosure is not limited thereto. In some cases, system 100 may obtain a large number of characteristics for a customer.

At step 352, system 100 determines, by the bandit model, a relationship between the one or more customer characteristics and the corresponding one or more content characteristics of the email templates. For instance, system 100 provides the customer characteristics and content characteristics to the contextual bandit model and applies the bandit algorithm to correlate the customers and a set of “arms” (e.g., email templates including creatives C1, C2, C3 and C4) with their corresponding feature vectors. The feature vector, also referred to as a context vector, is configured to summarize information of the customer and the creative received by the particular customer.

At step 353, system 100 updates the bandit model in accordance with the relationship, or correlation, between customer characteristic(s) and content characteristic(s) determined in step 352. More particularly, the bandit algorithm improves its arm-selection strategy based on correlations between the customer characteristics with the content characteristics and the performance criteria. For example, the performance criteria may include a click through rate (CTR) or a responding rate of the advertising content in the email. The performance criteria are referred to as the “payoff” in the bandit algorithm. In some embodiments, the expected payoff of the email templates is the click through rate. That is, choosing an email template with maximum CTR is equivalent to maximizing the expected number of clicks from customers, and maximizing the total expected payoff in the bandit formulation. Thus, by the above operations, system 100 can update the bandit model in accordance with the response information from the customers who receives the emails in this cycle.

Returning to FIG. 3, at step 360, system 100 determines a revised allocation of the email templates among prospective customer recipients, which will be applied in a second email cycle, by the updated bandit model. For further understanding of operations of step 360, reference is made to FIG. 5. FIG. 5 is a flowchart illustrating in greater detail operations of step 360 in the method 300, consistent with the disclosed embodiments. As shown in FIG. 5, in some embodiments, step 360 further includes steps 361, 362, and 363.

At step 361, system 100 obtains the one or more customer characteristics of respective ones of second customers who are targeted as recipients in a next, here second, email cycle. For example, system 100 may review characteristics, such as credit scores, incomes, ages, etc., of the second customers.

Then, at step 362, for respective ones of the second customers, system 100 estimates, by the bandit model, predicted responses corresponding to the email templates in accordance with the one or more customer characteristics. More particularly, in some embodiments, system 100 may provide the obtained customer characteristics associated with a specific customer to the bandit model. Accordingly, based on the customer characteristic(s), the bandit model makes an estimation regarding predicted responses of the specific customer to the email templates. Then, at step 363, system 100 selects one of the email templates for each of the second customers based on the predicted responses. For example, based on the observation in the previous cycle, the bandit algorithm may predict that customers having a high credit score and high income are more responsive to a specific creative (e.g., creative C1) compared to other creatives. Accordingly, if the characteristics of a customer targeted in the next cycle match the corresponding credit score and income criteria, system 100 selects the email template including the specific creative (e.g., creative C1) to include in the email sent to the customer.

In other words, system 100 can use a set of informative features to describe customers, email templates, and their relationship. Thus, system 100 may infer a target customer's interest based on his or her personal information, financial information, or any other information accessible, to choose a creative or an email template that is interesting or meets his or her need. By the above operations, system 100 can determine a revised allocation of the email templates. After determining the revised allocation applied in the second cycle, system 100 sends second emails respectively to second customers in accordance with the revised allocation. It is noted that, the allocation of the email templates may be further revised in following cycles based on the bandit model updated in each cycle. That is, new predictions about the customer preferences can be made in following cycle(s), e.g., a third or a fourth cycle, and not limited to the predictions made in previous cycle(s). Accordingly, before a “winner” is identified, system 100 performs exploration and exploitation at the same time.

In some embodiments, system 100 may further identify the “winner” from the candidates by the bandit algorithm. At step 370, system 100 determines if an optimized email template is identified corresponding to one or more customer characteristics among the email templates in accordance with the revised allocation and the response information. In other words. system 100 determines whether an optimized creative, also known as a “winner” choice with the best rewards in multi-armed bandit problem, is found. If the winner choice is not identified by the bandit algorithm, system 100 repeats steps 330-370, in order to collect more data and update the bandit model accordingly in following email cycles. Thus, the bandit model learns from the results in each round, and continually updates the customer segmentation and creative allocation in an automated manner. Customer segmentation refers to the process of dividing customers based on customer characteristics and/or customer responses to respective email templates. That is, by collecting feedback from customers, the bandit model can divide and/or reallocate customers into groups, i.e., “segments,” that can be targeted more accurately.

On the other hand, if the bandit algorithm identifies the optimized email template, step 380 is performed. At step 380, in a third email cycle, system 100 sends third emails with the optimized email template to third customers corresponding to the one or more customer characteristics after the optimized template is identified. For each customer segment, the optimized email template can be identified independently. Alternatively stated, a creative (e.g., creative C1) may be included in the optimized email template for one customer segment, and another creative (e.g., creative C2) may be included in the optimized email template for another customer segment.

In some embodiments, system 100 may identify the optimized email template in accordance with the response information after a predetermined number of iterations of sending emails, compiling response information, and revising allocation of the email templates. For example, system 100 may repeat steps 330-370 for four email cycles. After four email cycles, system 100 identifies the “winner,” i.e., the optimized email template for each customer segment by the bandit algorithm. Thus, in the following email cycles, system 100 may execute exploitation to maximize the click through rate. In some other embodiments, system 100 identifies the “winner,” i.e., the optimized email template if one creative outperforms other creatives for the customer segment by a threshold value. For example, if a difference between the click through rate of a leading creative (e.g., creative C1) and of other creatives is greater than 2%, the leading creative may be identified as the winner. However, other criteria can be applied to determine the “winner” based on requirements for, and relative performance of, creatives in a particular situation.

The above described processes may be implemented as a computer program or application or as a plugin module or sub component of another application. Some of the described processes may be executed by system 100 in FIG. 2. For example, system 100 may perform method 300 by executing stored instructions and/or programs. The described techniques may be varied and are not limited to the examples or descriptions provided.

Accordingly, by performing method 300 described above, the bandit model learns and improves its understanding about how customer characteristics affect preference for different advertising elements, i.e., creatives, in email cycles. Thus, system 100 can predict the preferences according to customer characteristics, and send out emails including the creative related to the needs of each recipient, in order to achieve creative optimization and improve advertising efficiency in the email marketing campaign.

FIG. 6 is a schematic diagram which illustrates an example of reallocating email templates in successive email cycles, consistent with disclosed embodiments. As shown in FIG. 6, in an initial stage (e.g., a first cycle), creatives C1-C4 are evenly distributed (e.g., 25% for each creative) to the recipients. After receiving and compiling responses collected in the first cycle, the bandit model is updated. In a second cycle, the bandit algorithm determines a different allocation in which 5% of the emails sent out contain creative C1, 14% of the emails contain creative C2, 66% of the emails contain creative C3, and 14% of the emails contain creative C4. Based on successive updates of the bandit model in each email cycle, the bandit algorithm updates allocations in third and fourth cycles. In the embodiments that emails are sent daily, the bandit model may update the allocations seven times within one week. In the embodiments that emails are sent on a weekly basis, the bandit model may update the allocations four times within one month. Accordingly, in each cycle, system 100 adjusts exploration and exploitation to improve the long-term advertising performance.

Assuming the collected data is large enough, the bandit model is able to provide accurate predictions. Size of the collected data may vary based on different scales of different email marketing campaigns. In one example, the bandit model may provide accurate predictions after about 70,000 emails are sent, but the present disclosure is not limited thereto. The number of emails sent in one email marketing campaign for updating the bandit model can vary from thousands to millions. Accordingly, based on the observation, new creatives can be generated and existing creatives with poor feedback can be deleted.

FIG. 7 is a schematic diagram which illustrates an automated pipeline 700 for identifying segments of customers for receiving email advertisements, consistent with the disclosed embodiments. In some embodiments, operations mentioned in FIG. 7 may be implemented in a cloud infrastructure. Various microservices in the cloud infrastructure can call each other to develop an email marketing platform for the email marketing campaign.

As shown in FIG. 7, system 100 generates email templates respectively corresponding to different customer marketing communications and determines a number of customers for receiving each email template in accordance with an initial allocation 710. Then, system 100 sends first emails 712 to first customers 714. Each of first emails 712 includes one of the email templates in accordance with initial allocation 710.

After customers 714 receive emails 712 including the corresponding creatives, system 100 receives response information 716 to first emails 712 from first customers 714 and determines a revised allocation 718 of the email templates by a contextual bandit model 720 based on received response information 716.

More particularly, the response information 716 may be received by the email marketing platform in real-time and batched as input for contextual bandit model 720 in a next cycle. System 100 calls the contextual bandit API and feeds the response information 716 to contextual bandit model 720. Contextual bandit model 720 compiles the batched response information 716 about responses of first customers 714 to first emails 712 and updates the contextual bandit model 720 based on the compiled results accordingly, consistent with method 300 in FIG. 3. In some embodiments, contextual bandit model 720 clusters first customers 714 in different segments in accordance with one or more customer characteristics, and compiles customer segment response information of first customers 714 clustered in the segments for each of the email templates.

The updated contextual bandit model 720 is configured to apply the response information from the customers 714 in the bandit model to refine predictions and determine revised allocation 718. As shown in FIG. 7, updated contextual bandit model 720 can apply the response information from customers 714 in the bandit model to determine customer response estimation values 730 corresponding to the email templates. Thus, contextual bandit model 720 can determine the revised allocation in accordance with the customer response estimation values obtained from the bandit model.

In some embodiments, contextual bandit model 720 determines the revised allocations respectively corresponding to the segments of customers in accordance with the response information. Contextual bandit model 720 may apply the customer segment response information in the bandit model to determine customer response estimation values 730 corresponding to the email templates and the segments of customers, and then determine revised allocations 718 respectively corresponding to the customer segments in accordance with the customer response estimation values 730.

Reference is also made to FIG. 8 for further understanding of the embodiments. FIG. 8 is a bar chart diagram illustrating an example of the customer response estimation values 730, consistent with disclosed embodiments. As shown in FIG. 8, for customers in different segments S1-S4, the click through rates (CTR) associated with different creatives have different patterns. For example, for the segment S1, customers are predicted to have a higher CTR responding to creative C1 compared to other creatives. On the other hand, for segment S2, customers are predicted to have a higher CTR responding to creative C2, and so on. Thus, based on these observations, system 100 may determine the allocations for different segments in the next cycle.

Reference is again made to FIG. 7. After the revised allocation 718 is determined, the system 100 can determine a number of customers for receiving each of the email templates in accordance with the revised allocation 718 and send second emails 722 to second customers 724 in the next email cycle. In some embodiments, when sending emails to customers, the email marketing platform can call the contextual bandit API with customer characteristics, in order to obtain a response from the contextual bandit API regarding what creative to be sent to a specific customer. In some embodiments, the email marketing platform may also call the contextual bandit API to return the allocation of the email templates based on the current prediction. A system in charge of sending email can thus determines targeted recipients in the following cycle based on the output of the contextual bandit API. Other applications may also be implemented based on actual needs in different email marketing campaigns, and thus examples provided herein are not meant to limit the present disclosure.

In addition, the performance of the contextual bandit model 720 can be monitored by a monitoring module 750 in system 100. Similar to the operation mentioned above, after system 100 applies the response information from customers 714 in the contextual bandit model 720 to determine customer response estimation values corresponding to the email templates, the customer response estimation values are sent to monitoring module 750. System 100 can compare, by monitoring module 750, the customer response estimation values with actual customer responses in historical data to rate a model performance of the bandit model. Thus, if the model performance decreases significantly or is abnormally poor after cycles of iterations, system 100 may identify the issue and take action to improve the poorly trained model. For example, system 100 may reset contextual bandit model 720 and train the model again if the model performance is below expectation for a number of consecutive cycles.

In some embodiments, system 100 may repeat the above processes, and send corresponding emails to customers, in accordance with the allocation, intermittently in multiple cycles. That is, in each of the cycles, the allocation of the email templates for a next cycle is updated by contextual bandit model 720 in accordance with responses of customers receiving the emails in a previous cycle.

In view of above, in various embodiments of the present disclosure, system 100 can implement an automated procedure for identifying user segments and a self-updated bandit model to improve the advertising efficiency by an iterative process. In addition, system 100 can achieve an appropriate exploration and exploitation using the contextual bandit framework, and improve the performance of targeted email marketing.

The various example embodiments herein are described in the general context of method steps or processes, which may be implemented in one aspect by a computer program product, embodied in a transitory or a non-transitory computer-readable medium, including computer-executable instructions, such as program code, executed by computers in networked environments. A computer-readable medium may include removeable and nonremovable storage device(s) including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the drawings and specification, there have been disclosed exemplary embodiments. It will be apparent to those skilled in the art that various modifications and variations can be made to the disclosed system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

1. (canceled)

2. A system for automatically optimizing content allocation and user segmentation, wherein the system is configured to continually update user segmentations of users and update content allocations based on the continually updated user segmentations, the system comprising:
memory storing computer program instructions; and
one or more processors that, when executing the computer program instructions, effectuate operations comprising:
obtaining a first set of user feature vectors respectively associated with a first plurality of users, wherein each user feature vector of the first set of user feature vectors includes features encoding characteristics of a respective user of the first plurality of users;
segmenting the first plurality of users into first user groups based on the first set of user feature vectors;
obtaining a set of content feature vectors respectively associated with a plurality of content items, wherein each content feature vector of the set of content feature vectors includes features encoding characteristics of a respective content item of the plurality of content items;
for each user group of the first user groups, selecting and sending a first content item to users of the user group, the first content item being selected from the plurality of content items;
obtaining response information from at least some of the first plurality of users responsive to being sent a corresponding first content item, wherein the response information indicates a performance of each first content item of the plurality of content items sent to a corresponding user of the first plurality of users;
training a machine learning model based on the first set of user feature vectors, the set of content feature vectors, and the response information to obtain a trained machine learning model, wherein the trained machine learning model correlates the features encoding characteristics of each user of first plurality of users with the features encoding characteristics of each content item of the plurality of content items based on the response information;
obtaining a second set of user feature vectors respectively associated with a second plurality of users, wherein each feature vector of the second set of user feature vectors includes features encoding characteristics of a respective user of the second plurality of users;
segmenting the second plurality of users into second user groups based on the second set of user feature vectors; and
for each user group of the second user groups, selecting and sending a second content item to users of the user group based on the second set of user feature vectors and the trained machine learning model, the second content item being selected from the plurality of content items.

3. The system of claim 2, wherein the operations further comprise:
obtaining additional response information from at least some of the second plurality of users responsive to being sent a corresponding second content item, wherein the additional response information indicates a performance of each second content item of the plurality of content items sent to a corresponding user of the second plurality of users;
updating the trained machine learning model based on the second set of user feature vectors, the set of content feature vectors, and the additional response information to obtain an updated machine learning model, wherein the updated machine learning model comprises an updated correlation of the features encoding characteristics of each user of first plurality of users and the features encoding characteristics of each user of the second plurality of users with the features encoding characteristics of each content item of the plurality of content items based on the additional response information;
obtaining a third set of user feature vectors respectively associated with a third plurality of users, wherein each feature vector of the third set of user feature vectors includes features encoding characteristics of a respective user of the third plurality of users;
segmenting the third plurality of users into third user groups based on the third set of user feature vectors; and
for each user group of the third user groups, selecting and sending a third content item to users of the user group based on the third set of user feature vectors and the updated machine learning model, the third content item being selected from the plurality of content items.

4. The system of claim 2, wherein selecting the second content item comprises:
providing the second set of user feature vectors to the trained machine learning model, wherein the trained machine learning model is configured to:
compute, for each content item of the plurality of content items, a value representing an estimated performance of the content item for each user of the second plurality of users based on the second set of user feature vectors and the trained machine learning model; and
determine the second content item to be sent to each user group of the second user groups based on the computed value for each content item of the plurality of content items.

5. The system of claim 2, wherein the operations further comprise:
obtaining additional response information from at least some of the second plurality of users responsive to being sent a corresponding second content item, wherein the additional response information indicates a performance of each second content item of the plurality of content items sent to a corresponding user of the second plurality of users;
computing a performance of each second content item with respect to a corresponding second user group based on the additional response information; and
determining whether the performance of any second content item satisfies a content optimization condition, wherein the content optimization condition being satisfied comprises a difference between a performance of a second content item with respect to a given second user group and a performance of each other second content items with respect to that other second content item's second user group being greater than or equal to a threshold value.

6. A non-transitory computer-readable medium storing computer program instructions that, when executed by one or more processors, effectuate operations comprising:
segmenting a first plurality of users into first user groups based on a first set of user feature vectors respectively associated with the first plurality of users;
for each user group of the first user groups, selecting and sending a first content item to users of the user group, wherein the first content item is selected from a plurality of content items;
obtaining response information from at least some of the first plurality of users responsive to being sent a corresponding first content item;
training a machine learning model based on the first set of user feature vectors, a set of content feature vectors respectively associated with the plurality of content items, and the response information to obtain a trained machine learning model;
segmenting a second plurality of users into second user groups based on a second set of user feature vectors respectively associated with the second plurality of users; and
for each user group of the second user groups, selecting and sending a second content item to users of the user group based on the second set of user feature vectors and the trained machine learning model, wherein the second content item is selected from the plurality of content items.

7. The non-transitory computer-readable medium of claim 6, wherein:
each user feature vector of the first set of user feature vectors includes features encoding characteristics of a respective user of the first plurality of users;
each feature vector of the second set of user feature vectors includes features encoding characteristics of a respective user of the second plurality of users; and
each content feature vector of the set of content feature vectors includes features encoding characteristics of a respective content item of the plurality of content items.

8. The non-transitory computer-readable medium of claim 6, wherein the trained machine learning model correlates features encoding characteristics of each user of first plurality of users with features encoding characteristics of each content item of the plurality of content items based on the response information.

9. The non-transitory computer-readable medium of claim 6, wherein the first plurality of users differs from the second plurality of users.

10. The non-transitory computer-readable medium of claim 6, wherein:
the first content item is randomly selected from the plurality of content items randomly for each user group of the first user groups or based on the first set of user feature vectors; or
the first content item is selected from the plurality of content items based on the first set of user feature vectors and the set of content feature vectors.

11. The non-transitory computer-readable medium of claim 6, wherein the response information indicates a performance of each content item of the plurality of content items sent to a corresponding user of the first plurality of users.

12. The non-transitory computer-readable medium of claim 6, wherein the operations further comprise:
obtaining additional response information from at least some of the second plurality of users responsive to being sent a corresponding second content item; and
updating the trained machine learning model based on the second set of user feature vectors, the set of content feature vectors, and the additional response information to obtain an updated machine learning model, wherein the updated machine learning model is used to select which of the plurality of content items is to be sent to third user groups associated with a third plurality of users.

13. The non-transitory computer-readable medium of claim 12, wherein the operations further comprise:
computing a first performance of the trained machine learning model based on the response information;
computing a second performance of the updated machine learning model based on additional response information received from at least some of the second plurality of users responsive to being sent a corresponding second content item; and
determining whether the updated machine learning model is to be reset or retrained based on the first performance and the second performance.

14. The non-transitory computer-readable medium of claim 12, wherein the operations further comprise:
obtaining a third set of user feature vectors respectively associated with the third plurality of users;
segmenting the third plurality of users into third user groups based on the third set of user feature vectors; and
for each user group of the third user groups, selecting and sending a third content item to users of the user group based on the third set of user feature vectors and the updated machine learning model, the third content item being selected from the plurality of content items.

15. The non-transitory computer-readable medium of claim 6, wherein selecting the second content item comprises:
computing, for each content item of the plurality of content items, a value representing an estimated performance of the content item for each user of the second plurality of users based on the second set of user feature vectors and the trained machine learning model; and
determining the second content item to be sent to each user group of the second user groups based on the computed value for each content item of the plurality of content items.

16. The non-transitory computer-readable medium of claim 6, wherein the operations further comprise:
obtaining additional response information from at least some of the second plurality of users responsive to being sent a corresponding second content item; and
determining whether a performance of each second content item satisfies a content optimization condition, wherein in response to the second content item satisfying the content optimization condition, the second content item is selected as an optimized content item for users of a corresponding user group.

17. A method implemented by one or more processors that, in response to executing computer program instructions, perform the method, the method comprising:
segmenting a first plurality of users into first user groups based on a first set of user feature vectors respectively associated with the first plurality of users;
for each user group of the first user groups, selecting and sending a first content item to users of the user group, wherein the first content item is selected from a plurality of content items;
obtaining response information from at least some of the first plurality of users responsive to being sent a corresponding first content item;
training a machine learning model based on the first set of user feature vectors, a set of content feature vectors respectively associated with the plurality of content items, and the response information to obtain a trained machine learning model;
segmenting a second plurality of users into second user groups based on a second set of user feature vectors respectively associated with the second plurality of users; and
for each user group of the second user groups, selecting and sending a second content item to users of the user group based on the second set of user feature vectors and the trained machine learning model, wherein the second content item is selected from the plurality of content items.

18. The method of claim 17, further comprising:
obtaining additional response information from at least some of the second plurality of users responsive to being sent a corresponding second content item; and
updating the trained machine learning model based on the second set of user feature vectors, the set of content feature vectors, and the additional response information to obtain an updated machine learning model, wherein the updated machine learning model is used to select which of the plurality of content items is to be sent to third user groups associated with a third plurality of users.

19. The method of claim 18, further comprising:
computing a first performance of the trained machine learning model based on the response information;
computing a second performance of the updated machine learning model based on additional response information received from at least some of the second plurality of users responsive to being sent a corresponding second content item; and
determining whether the updated machine learning model is to be reset or retrained based on the first performance and the second performance.

20. The method of claim 18, further comprising:
obtaining a third set of user feature vectors respectively associated with the third plurality of users;
segmenting the third plurality of users into third user groups based on the third set of user feature vectors; and
for each user group of the third user groups, selecting and sending a third content item to users of the user group based on the third set of user feature vectors and the updated machine learning model, the third content item being selected from the plurality of content items.

21. The method of claim 17, wherein selecting the second content item comprises:
computing, for each content item of the plurality of content items, a value representing an estimated performance of the content item for each user of the second plurality of users based on the second set of user feature vectors and the trained machine learning model; and
determining the second content item to be sent to each user group of the second user groups based on the computed value for each content item of the plurality of content items.
